(19) United States
(12) Patent Application Publication
(10) Pub. No.: US 2011/0259159 A1
(43) Pub. Date: Oct. 27, 2011

(54) WRENCH WITH CLAMPING FUNCTIONS AND OPERATING METHOD THEREOF

(75) Inventor: Chih-Ching HSIEH, Taichung City 420 (TW)

(73) Assignee: KABO TOOL COMPANY, Taichung City (TW)

(21) Appl. No.: 13/091,163

(22) Filed: Apr. 21, 2011

(30) Foreign Application Priority Data
Apr. 23, 2010 (TW) 99112939

(51) Int. Cl. B25B 23/10

(52) U.S. Cl. 81/125

(57) ABSTRACT

A wrench with clamping functions is disclosed. The wrench includes a main body, a forcing jaw, a restraining jaw, and a clamping device disposed on the restraining jaw. The main body has an extending direction. The end of the forcing jaw is further from the main body than the end of the restraining jaw along the extending direction. The clamping device includes an elastic member and a block supported by the elastic member and protruded towards a forcing surface of the forcing jaw. When the block is pressed by an exterior force from a workpiece, the block can be partially pushed back into a space of the restraining jaw. On the other hand, the block returns to the origin position if the exterior force is removed, and the workpiece is clamped by the protruded block and the forcing jaw.

### RELATED APPLICATIONS

The application claims priority to Taiwan Application Serial Number 99112939, filed Apr. 23, 2010, which is herein incorporated by reference.

### BACKGROUND

1. Technical Field

The present disclosure relates to a wrench. More particularly, the present disclosure relates to a wrench with clamping functions.

2. Description of Related Art

The wrench is a common tool. The wrench may fit on one end of a bolt or a nut for rotation. Moreover, the wrench can rotate the bolt or the nut by using a polygonal socket.

In use, the wrench usually cooperates with other workpiece (such as a nut or a socket). In general, the workpiece is first aimed at an object (such as a bolt) manually, and then is combined with the wrench. However, since the size of the workpiece is small, it is quite inconvenient to hold the workpiece by hand. Moreover, after the work is done, when being removed from the object necessarily, the workpiece often falls from the user's hand accidentally. There is an existing skill of disposing one or more magnetic members on two jaws of the wrench for attracting the aforementioned small workpiece, thereby preventing the workpiece from falling.

However, the wrench with the magnetic members can only work for the workpiece made of the material which can be attracted by the magnetic members. Furthermore, the magnetic members may cause the failure of electronic components, and thus are not suitable for all working conditions.

### SUMMARY

An aspect of the present disclosure is to provide a wrench with clamping functions. The wrench includes a main body, a forcing jaw, a restraining jaw, and a clamping device disposed on the restraining jaw. The main body has an extending direction. The end of the forcing jaw is further from the main body than the end of the restraining jaw along the extending direction.

According to one embodiment of the present disclosure, the clamping device includes a block and an elastic member supporting the block. The block is supported by the elastic member and protrudes towards the forcing jaw. When being pressed by an exterior force from a workpiece, the block can be partially pushed back into a space of the restraining jaw. On the other hand, the block returns to the origin position if the exterior force is removed. According to another embodiment of the present disclosure, the restraining jaw includes a groove, and the groove has an aperture located on its restraining surface. The elastic member is held in the groove. The block is supported by the elastic member, and the block partially protrudes from the aperture. The block is partially or fully moved into the groove when being pressed by an exterior force. The block returns to the origin position when the exterior force is removed.

Another aspect of the present disclosure is to provide a method for operating the wrench with clamping functions. The method includes the following steps. A workpiece is positioned at an opening defined by the forcing jaw and the restraining jaw, and contacts the forcing jaw and the block of the restraining jaw, and is clamped in the opening.

As described before, the wrench may adapt to the shape and size of the workpiece automatically for firmly clamping the workpiece in the opening without falling off. In addition, the clamping device is disposed on the restraining jaw for avoiding the effect caused by an application force. Moreover, the clamping device has good abrasion resistance. The workpiece may provide a sense of positioning for engaging with the workpiece, thereby enabling the work to be performed conveniently and smoothly.

### BRIEF DESCRIPTION OF THE DRAWINGS

FIG. 1 is a three-dimensional view of a wrench according to one embodiment of the present disclosure.

FIG. 2A is an exploded view of the wrench of FIG. 1.

FIG. 2B is a cross-sectional view of the clamping device of the wrench of FIG. 1.

FIG. 3 illustrates the wrench of FIG. 1 in one operating mode.

FIG. 4 illustrates the wrench of FIG. 1 in another operating mode in which the wrench removes a workpiece from an object.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

In other instances, well-known structures and devices are schematically shown in order to simplify the drawings.

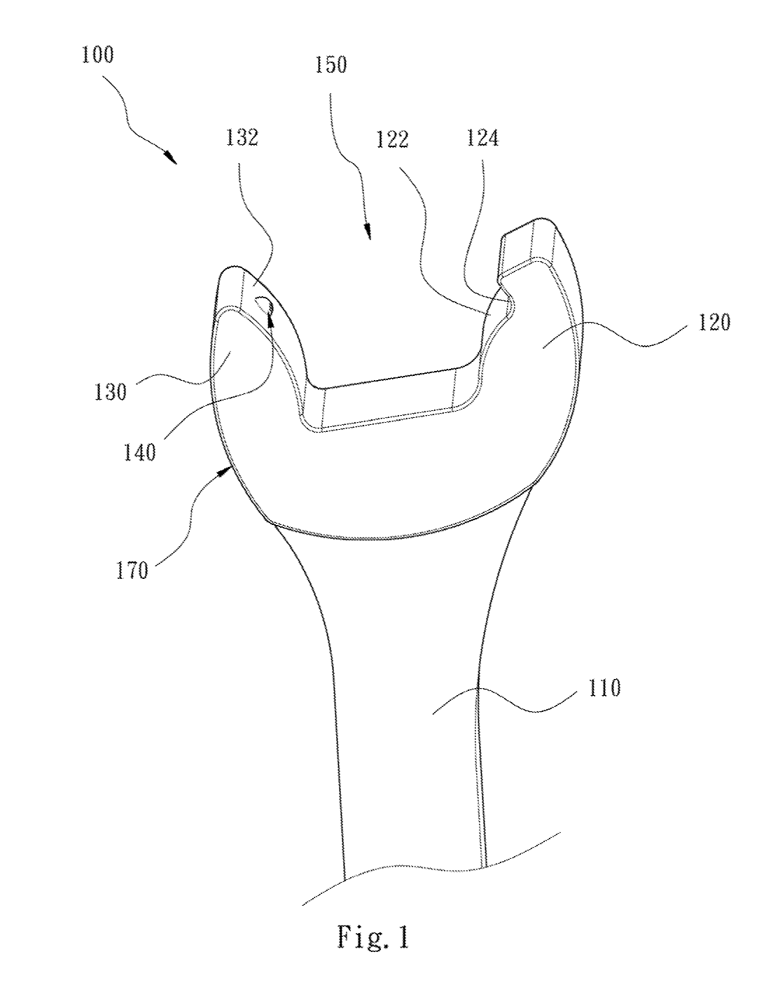

FIG. 1 is a three-dimensional view of a wrench 100 according to one embodiment of the present disclosure. The wrench 100 includes a main body 110, a forcing jaw 120, a restraining jaw 130, and a clamp device 140.

The main body 110 has an extending direction. The forcing jaw 120 is disposed on one end of the main body 110. The forcing jaw 120 has a forcing surface 122. The restraining jaw 130 is disposed on the same end with the forcing jaw 120, and the restraining jaw 130 is opposite to the forcing jaw 120. The end of the forcing jaw 120 is further from the main body 110 than the end of the restraining jaw 130 along the extending direction for rotating a workpiece 200. The restraining jaw 130 has a restraining surface 132 opposite to the forcing surface 122. The forcing surface 122 and the restraining surface 132 define an opening 150.

According to one embodiment, the forcing surface 122 has at least one indentation 124 for fitting with a corner of the workpiece 200. The indentation 124 is a force point for pushing and rotating the workpiece 200. The restraining surface 132 is a curved surface or a flat surface for providing a resistance against the surface of the workpiece 200 while rotating the workpiece 200.

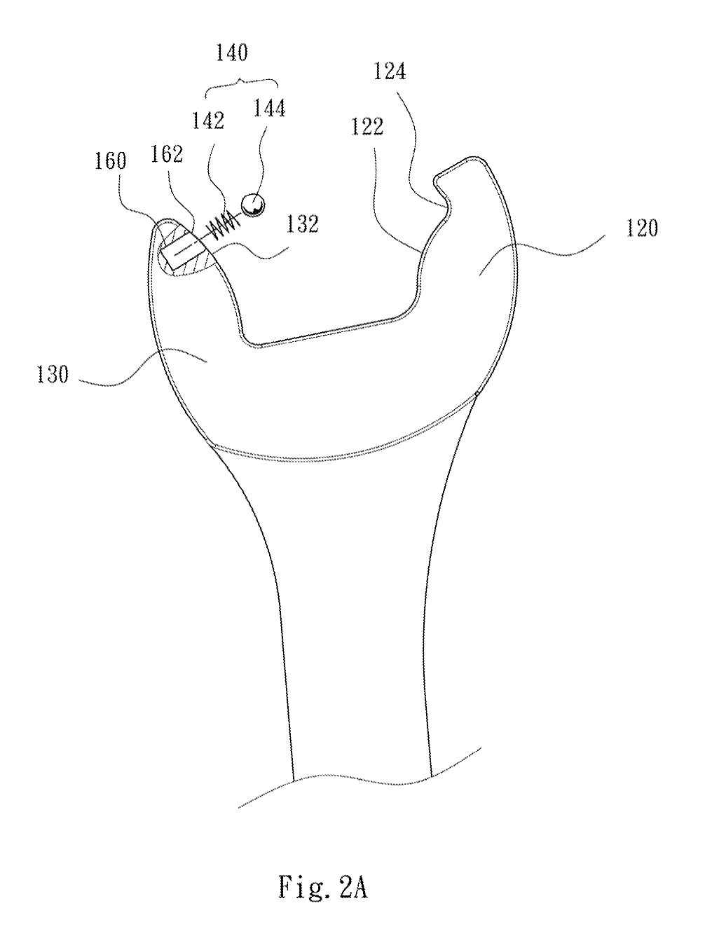

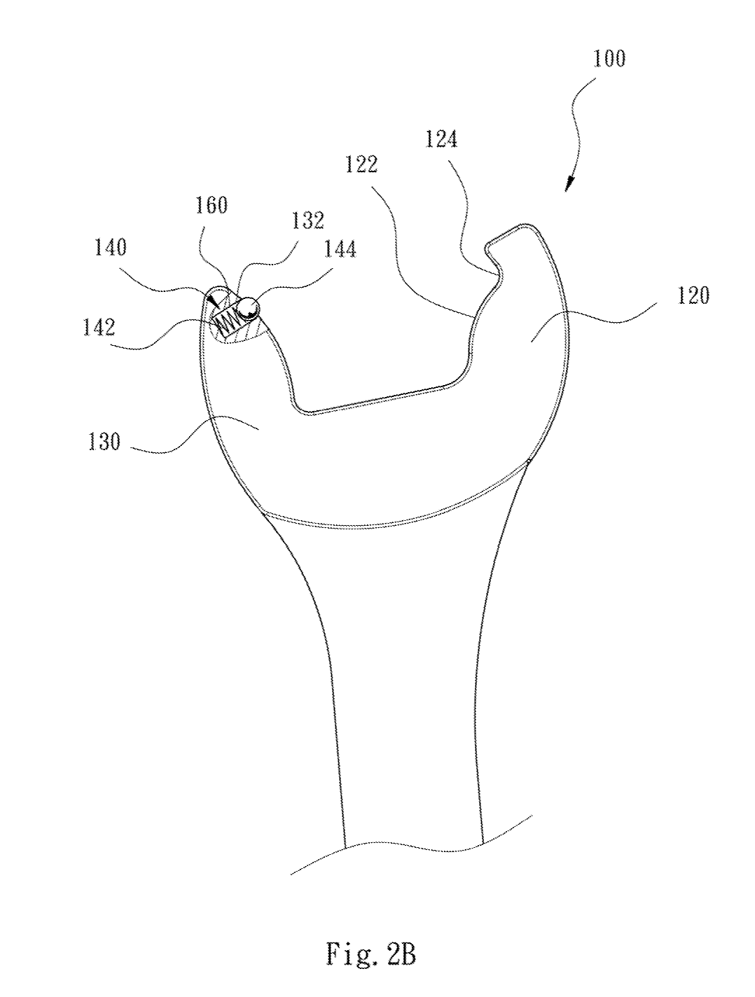

FIG. 2A is an exploded view of the wrench 100 of FIG. 1. The restraining jaw 130 includes a groove 160, and the groove 160 has an aperture 162 located on the restraining surface 132. The clamp device 140 includes an elastic member 142 and a block 144.

FIG. 2B is a cross-sectional view of the clamp device 140 of the wrench 100 of FIG. 1. The elastic member 142 is held in the groove 160. The block 144 is located at one end of the elastic member 142. The block 144 is supported by the elastic member 142 and protruds towards the forcing surface 122 from the restraining surface 132. According to one or more embodiments, the elastic member 142 is a spring or a reed, the block 144 is a ball, and the groove 160 is a through hole or a blind hole. One end of the groove 160 located on the outer side of the restraining jaw 130 and is sealed by a cover if the groove 160 is a through hole.

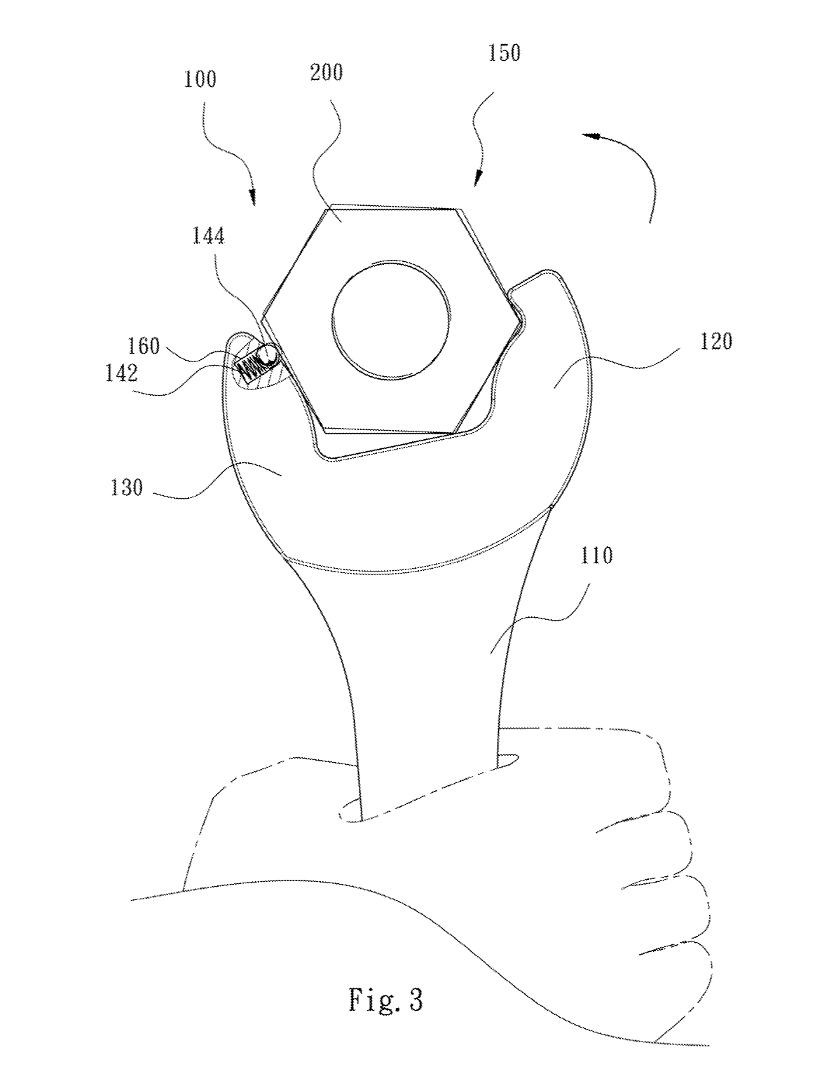

FIG. 3 illustrates the wrench 100 of FIG. 1 in one operating mode. The user takes the main body 110 of the wrench 100 for positioning the workpiece 200 at the opening 150 defined by the forcing jaw 120 and the restraining jaw 130. The block 144 is moved into the groove 160 when the user rotates the wrench 100 for rotating the workpiece 200 to make the corner or edge of the workpiece 200 contact the block 144. The block 144 is partially or fully moved into the groove 160 according to the exterior force from the corner or the edge of the workpiece 200.

When the exterior force of the corner or the edge of the workpiece 200 which presses the block 144 is removed with the rotation of the workpiece 200, the block 144 is moved towards the forcing jaw 120 and returns to the origin position. As illustrated in FIG. 3, the block 144 still contacts the corner or the edge of the workpiece 200 when the block 144 is moved towards the forcing jaw 120 for returning to the original position. The movement of the block 144 is decided in accordance with the shape of the corner or the edge of the workpiece 200.

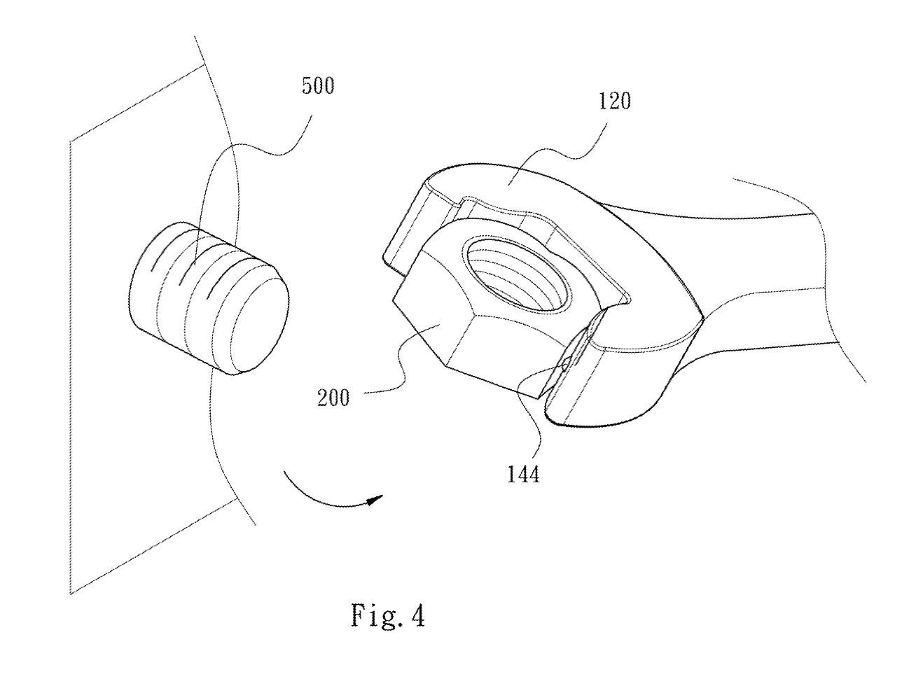

FIG. 4 illustrates the wrench 100 of FIG. 1 in another operating mode in which the wrench 100 removes the workpiece 200 from an object 500. The workpiece 200 contacts the forcing jaw 120 and the restraining jaw 130 and is held in the opening 150 by the block 144, when the elastic member 142 pushes the block 144 to press the corner or the edge of the workpiece 200 after the workpiece 200 is removed from the object 500.

As described above, the present disclosure has the following advantages:
1. Usability: The wrench 100 fits many sizes of the workpiece 200 for holding the workpiece 200 in the opening 150. Therefore, the wrench 100 is good at narrow working space without needing to hold the workpiece 200 by hand. Furthermore, the workpiece 200 would not fall while being removed.
2. Good strength: The forcing jaw 120 maintains the strength because the clamp device 140 is disposed on the restraining jaw 130, but not on the forcing jaw 120.
3. Little abrasion: The clamp device 140 has longer life and less abrasion by the workpiece 200, because the clamping is disposed on the restraining jaw 130.
4. Easy positioning: The block 144 presses the corner of the workpiece 200 for positioning the workpiece 200 according to the shape of the corner, when the workpiece 200 is at the opening 150 of the wrench 100.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A wrench with clamping functions comprising:
a main body having an extending direction;
a forcing jaw disposed on one end of the main body, the forcing jaw having a forcing surface;
a restraining jaw disposed on the same end with the forcing jaw and opposite to the forcing jaw, the restraining jaw and the forcing jaw defining an opening, the restraining jaw having a restraining surface opposite to the forcing surface, the end of the forcing jaw is further from the main body than the end of the restraining jaw along the extending direction; and
a clamping device disposed on the restraining jaw, the clamping device comprising:
an elastic member; and
a block supported by the elastic member for protruding towards the forcing surface, wherein the block moves towards the restraining surface when the block is pressed by an exterior force, and the block returns to the origin position when the exterior force is removed.

2. The wrench with clamping functions of claim 1, further comprising:
a groove for holding the elastic member, the groove having an aperture located on the restraining surface, the block partially protruding from the aperture.

3. The wrench with clamping functions of claim 2, wherein the block is partially or fully moved into the groove when the block is pressed by an exterior force, and the block returns to the origin position when the exterior force is removed.

4. The wrench with clamping functions of claim 2, wherein the groove is a through hole, and one end of the through hole located on the outer side of the restraining jaw is sealed by a cover.

5. The wrench with clamping functions of claim 1, wherein the block is a ball.

6. The wrench with clamping functions of claim 1, wherein the elastic member is a spring or a reed.

7. The wrench with clamping functions of claim 1, wherein the forcing surface has at least one indentation for fitting with a corner of a workpiece and pushing the workpiece for rotation.

8. The wrench with clamping functions of claim 1, wherein the restraining surface is a curved surface or a flat surface.

9. An operating method of a wrench with clamping functions of claim 1, comprising:
providing the main body of the wrench; and
positioning a workpiece at the opening defined by the forcing jaw and the restraining jaw, wherein the workpiece contacts the forcing jaw and the block for being held in the opening.

10. The operating method of claim 9, wherein the block presses and holds the workpiece as the block is supported by the elastic member.
